(19) United States
(12) Patent Application Publication
(10) Pub. No.: US 2014/0318344 A1
(43) Pub. Date: Oct. 30, 2014

(54) DIE WITH PROFILED BASE WALL AND ITS ASSOCIATED PUNCH

(71) Applicant: Greenlee Textron Inc., (US)

(72) Inventor: William F. Nordlin, Poplar Grove, IL (US)

(73) Assignee: Greenlee Textron Inc., Rockford, IL (US)

(21) Appl. No.: 13/874,022

(22) Filed: Apr. 30, 2013

(51) Int. Cl. B21D 28/24; B26F 1/38

(52) U.S. Cl. CPC B21D 28/24; B26F 1/386
USPC 83/685; 83/690

(57) ABSTRACT

An assembly includes a die and a punch which cut a hole in a workpiece. The die has a base wall having outer and inner surfaces and a passageway extending therethrough, and a wall extending from the base wall. The inner surface of the base wall has at least one portion which is angled relative to a central axis of the die. The punch includes a body having a bore therethrough, a leading edge on the body which is capable of piercing and cutting a workpiece, and cutting edges on the body for cutting a hole in the workpiece. The leading edge has inclined surfaces between the bore and the piercing points which engage with the portion of the inner surface of the die.

### FIELD OF THE INVENTION

The present invention relates to a die having a base wall having a profile that generally matches the profile of at least a portion of a leading edge of a punch.

### BACKGROUND OF THE INVENTION

Punches and their associated dies have been used for decades in construction and industry to make holes in workpieces, such as sheet metal, for field installation of electrical, plumbing, and heating/AC equipment.

FIGS. 1-4 show a prior art punch 10 which is used for punching a hole through a workpiece, such as sheet metal. This punch 10 is disclosed in U.S. Pat. No. 4,543,722, the disclosure of which is incorporated herein by reference in its entirety. The punch 10 is used with a die 40 (only partially shown in FIG. 3) which is well-known in the art, as well as a draw shaft (not shown).

The punch 10 has a contoured working face 14 which reduces the peak punching force by first piercing the workpiece and then shearing the circumference of the hole. The contoured working face 14 of the punch 10 has a profiled leading edge 29, which includes piercing points P1, P2 and cutting surfaces 30b, 32b, which causes the slug or scrap which is punched in the workpiece to he torn in half, making it easy for the slug or scrap to be removed from the die 40.

The die 40 has a circular planar base wall 42 with a circular depending wall 44 extending from the perimeter of the base wall 42. A central passageway 46 extends through the axial center of the base wall 42. The size of the die 40 is dictated by the size of the punch 10 used.

If the punch 10 is advanced too far into the die 40, the leading edge 29 of the punch 10 “bottoms” in the die 40, i.e., the punch points P1, P2/cutting surfaces 30b, 32b come into contact with the base wail 42 of the die 40, and damage to the punch points P1, P2/cutting surfaces 30b, 32b can result. Actuation of the punch 10/die 40 with an electric or power hydraulic device can advance the punch 10 so rapidly that the user may not stop the punching cycle before the punch 10 “bottoms” in the die 40. For this reason, manufacturers of punches/dies have long recommended only manual actuation of the punches/dies with a wrench. Use of electrohydraulics has been discouraged to prevent damage to the punch.

Mechanical and electrical contractors are seeking ways to reduce the time for field installation of conduit, pipe, and round ductwork. As a result, power punching of holes in sheet metal is increasingly replacing the traditional manual wrench methods.

Punches and their associated dies are sold separately from the various battery, electric, hydraulic and mechanical devices which are used to actuate the punch relative to the die. There are battery and corded electric hydraulic pump/ram tools which attempt to stop the advancing of the punch when an internal pressure sensor detects the drop in force when the punching cycle is complete. These pressure drop sensors tend not to be completely reliable on thinner steels, softer materials (i.e. copper, aluminum), and for smaller hole diameters. Punching systems which incorporate an internal pressure sensor are expensive and may be justifiable only for larger construction jobs. In addition, many electricians make use of their existing all-purpose industrial hydraulic pumps without the pressure drop sensor to actuate knockout punches.

A punch and die are provided herein which has integral cutting edge protection Which is independent of the various power driving systems. Other features and advantages of the present die will become apparent upon a reading of the attached specification, in combination with a study of the drawings.

### SUMMARY OF THE INVENTION

An assembly includes a die and a punch which are used to cut a hole in a workpiece. The die includes a base wall having a perimeter, an outer surface and an inner surface, a depending wall extending from the base wall and a passageway extending through the base wall. The inner surface of the base wall has at least one portion which is angled relative to a central axis of the die. The punch includes a body having a bore therethrough, a leading edge on the body which is capable of piercing a workpiece, and cutting edges on the body for cutting a hole in the workpiece. The leading edge has inclined surfaces between the bore and the piercing points which engage with the portion of the inner surface of the die when the leading edge engages with the inner surface of the base. The piercing points do not engage with the portion of the inner surface of the die when the leading edge engages with the inner surface of the base.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a side elevation view of a prior art punch;

FIG. 2 is a top plan view of the prior art punch;

FIG. 3 is a perspective view of the prior art punch, along with a prior art die which is only partially shown;

FIG. 4 is a cross-sectional view of the prior art punch engaged with the prior art die;

FIG. 5 is a perspective view of a punch which incorporates the features of the present invention;

FIG. 6 is a top plan view of the punch of FIG. 5;

FIG. 7 is a side elevation view of the punch of FIG. 5;

FIG. 8 is a perspective view of a die which incorporates the features of the present invention;

FIG. 9 is a top plan view of the die of FIG. 8;

FIG. 10 is a cross-sectional view along line 10-10 of FIG. 9; and

FIG. 11 is a cross-sectional view of the punch of FIG. 5 engaged with the die of FIG. 8, in the position just before the punch “bottoms” out on the die.

### DETAILED DESCRIPTION OF THE ILLUSTRATED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein. Therefore, unless otherwise noted, features disclosed herein may be combined together to form additional combinations that were not otherwise shown for purposes of brevity.

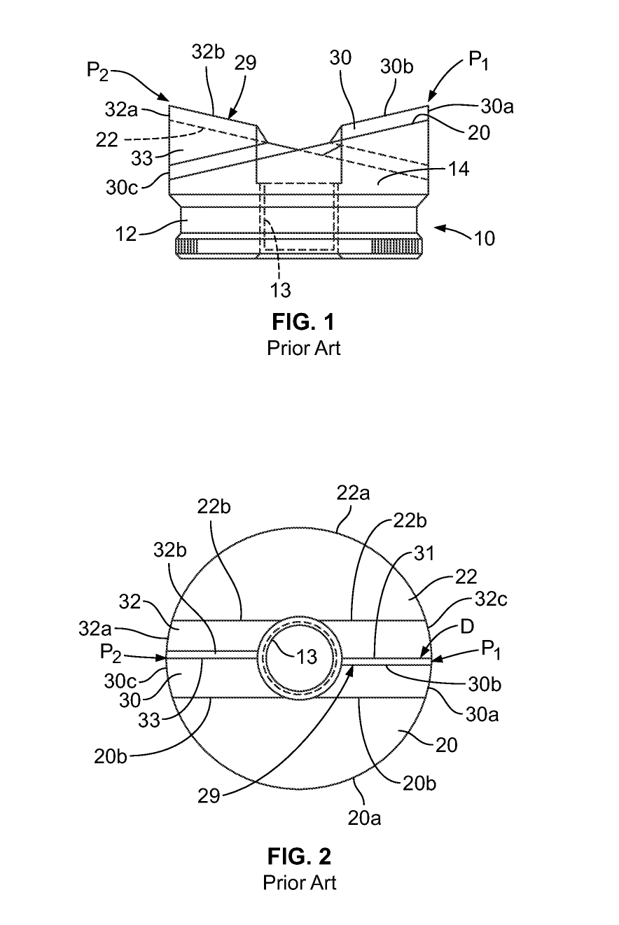

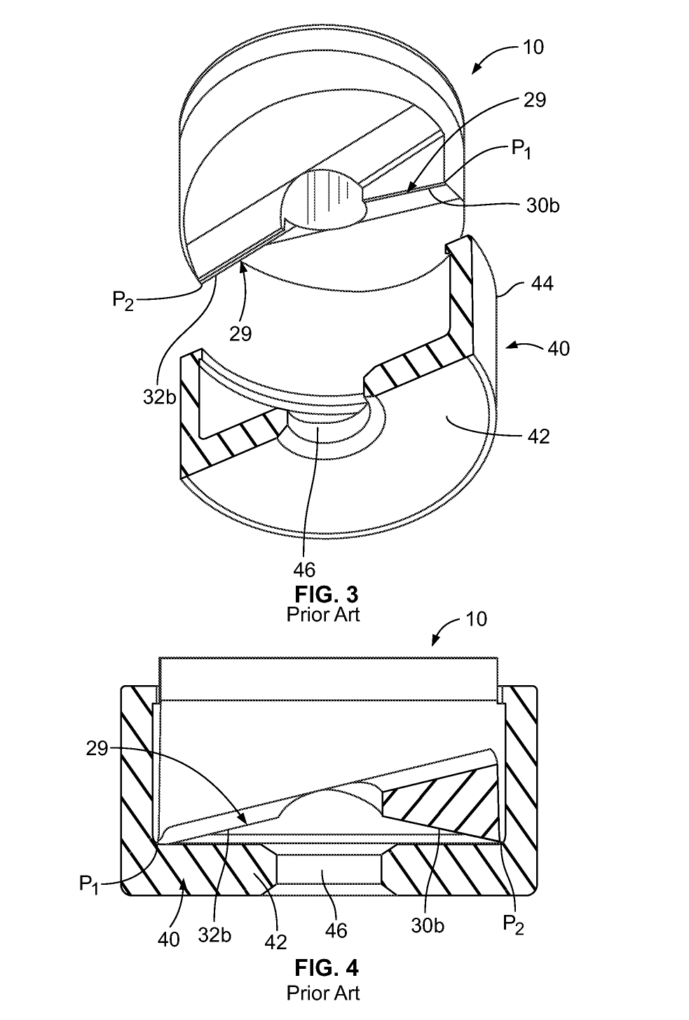

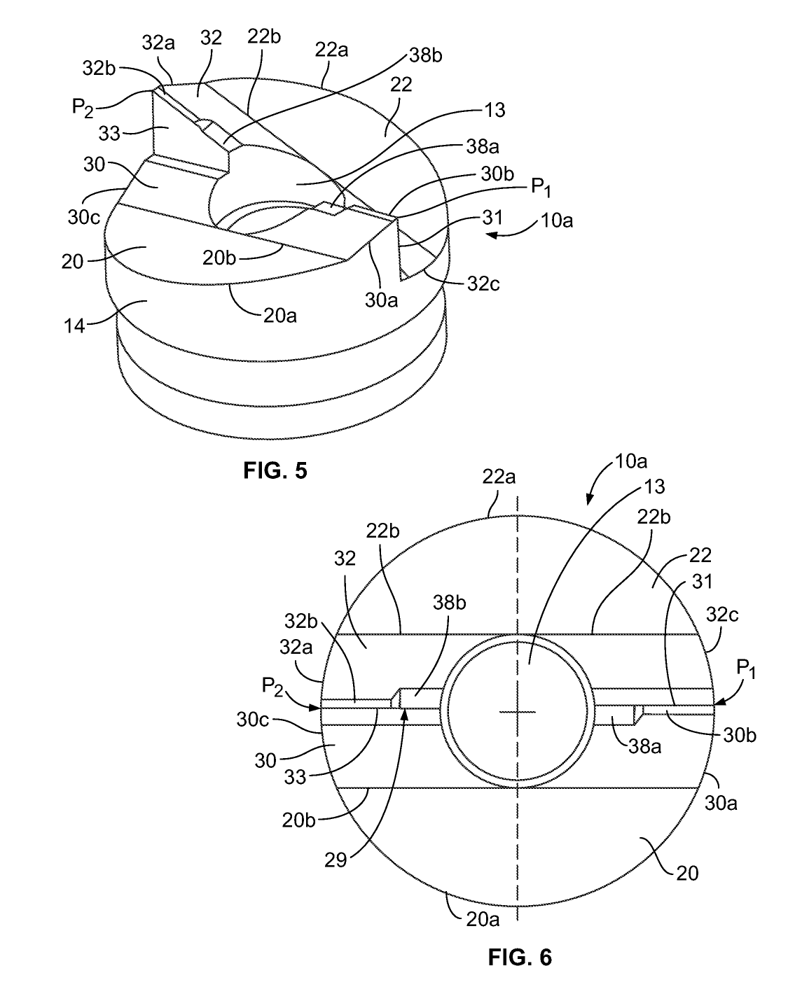

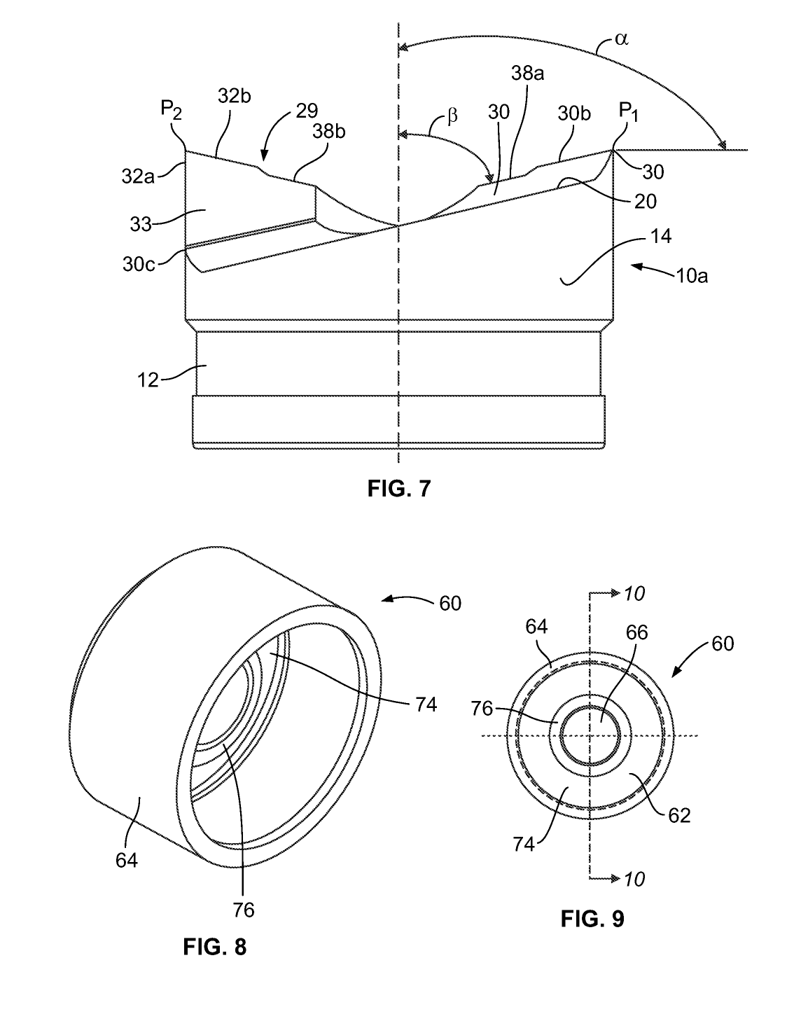

FIGS. 5-7 show the punch 10a which is used for punching a hole through a workpiece, such as sheet metal. In the present invention, the punch 10 has a profiled leading edge 29 and is used with a novel die 60, as well as a draw shaft (not shown). The punch 10a is identical to the prior art punch 10 shown in FIGS. 1-4, with the exception of inclined engaging surfaces 38a, 38b on the leading edge 29 as disclosed herein, and therefore, like reference numerals are used for the punch 10a as are used in the punch 10.

The punch 10a shown and described herein is illustrative of a type of punch that can be used in the present invention. It is to be understood that the specifics of the leading edge 29 described herein is not limiting, and that other leading edges than that shown and described can be used. The critical aspect of the present invention is that the profile of at least a portion of an inner surface 72 of the base wall 62 of the die 40 substantially conforms in shape to the engaging surfaces 38a, 38b of the leading edge 29 of the punch 10a.

The illustrative punch 10a is formed of metal and includes a generally cylindrical punch body 12 having a threaded bore 13 extending axially therethrough for thread ably receiving the threaded end of the draw shaft in a conventional manner. The punch 10a includes a contoured working face 14 transverse to its axis 15 which is used for punching and splitting a slug or scrap from the workpiece. The contoured working face 14 includes a pair of first inclined planar surfaces 20, 22 on opposite sides of the bore 13. The first planar surfaces 20, 22 slope upwardly from the working face 14 in opposite directions. The first planar surfaces 20, 22 have outer circumferential or peripheral edges which form first outer cutting edges 20a, 22a around a large portion of the periphery of the working face 14 when viewed in plan as shown in FIG. 6. The planar surfaces 20, 22 also have inner chordal ends 20b, 22b parallel with and spaced from diameter across the working face 14 in plan view. These chordal ends 20b, 22b are intersected by a pair of second inclined planar surfaces 30, 32. The second inclined planar surfaces 30, 32 slope upwardly from the lines of intersection at a steeper angle of inclination than the first planar surfaces 20, 22.

The second inclined planar surfaces 30, 32 include outer peripheral edges forming second outer circumferential edges 30a, 32a and third cutting edges 30c, 32c around a small portion of the periphery of the working face 14 when viewed in plan. The second inclined planar surfaces 30, 32 terminate laterally across the working face 14 on one side of the bore 13 between the first inclined planar surfaces 20, 22 in narrow lateral cutting surfaces 30b, 32b which are generally flat across and in vertically and radially oriented third surfaces 31, 33 on the other side of the bore 13 between the first inclined planar surfaces 20, 22. Each cutting surface 30b, 32b extends at angle α, which is preferably 77°, relative to the central axis 15. Each third surface 31, 33 extends vertically upward at a 90° angle from the respective second inclined planar surface 30, 32 and terminates at the respective lateral cutting surface 30b, 32b. The lateral cutting surfaces 30b, 32b extend generally toward one another and incline upwardly in opposite directions toward the associated second outer cutting edges 30a, 32a of the second inclined planar surfaces 30, 32. The lateral cutting surfaces 30b, 32b thus form a generally V-shaped lateral cutting means across the working face 14 when viewed in elevation.

Piercing points P1, P2 are formed on diametrically opposite sides of the periphery of the working face 14 at the junction of the lateral cutting surfaces 30b, 32b with the respective second cutting edges 30a, 32a. The piercing points P1, P2 initially pierce the workpiece in a triangular pattern and initiate lateral cutting across the slug diameter before a substantial portion of the slug circumference is cut. The uppermost height of the second cutting edges 30a, 32a above the respective first cutting surfaces 20a and 22a as well as their angle of slope and length (circumferential) is correlated with similar parameters for lateral cutting surfaces 30b, 32b to achieve this effect.

The punch 10a differs from the prior art punch 10 shown in FIGS. 1-4 in that a pair of inclined engaging surfaces 38a, 38b are provided. The engaging surfaces 38a, 38b extend from the bore 13 to the lateral cutting surfaces 30b, 32b. The engaging surfaces 38a, 38b are wider than the lateral cutting surfaces 30b, 32b such that the engaging surfaces 38a, 38b extend from the third surfaces 31, 33 past the edge of the cutting edges 30b, 32b and into the second inclined planar surfaces 30, 32. The engaging surfaces 38a, 38b preferably extends at angle β, which is preferably 77°, relative to the central axis 15. The engaging surfaces 38a, 38b are axially offset from the cutting surfaces 30b, 32b. The engaging surfaces 38a, 38b extend generally toward one another and incline upwardly in opposite directions toward the associated second outer cutting surfaces 30b, 30b.

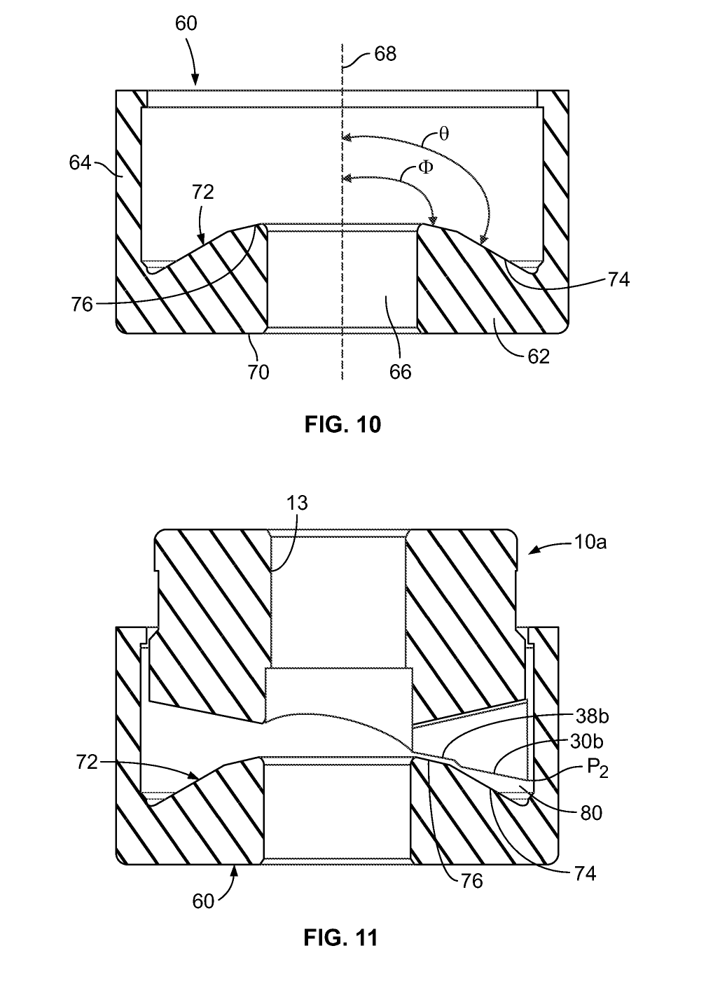

As shown in FIGS. 8-10, the die 60 is formed of metal and has a base wall 62 with a circular depending side wall 64 extending from the perimeter of the base wall 62. A central passageway 66 extends through the axial center of the base wall 62 and has a first end at the outer surface 70 of the base wall 62 and a second end at the inner surface 72 of the base wall 62. A central axis 68 extends through the axial center of the central passageway 66. The outer surface 70 of the base wall 62 is planar and perpendicular to the axis 68 and the inner surface 72 of the base wall 62 is contoured. The inner surface 72 has a first inclined surface 74 and a second inclined surface 76. The first inclined surface 74 extends from the juncture of the depending wall 64 to the second inclined surface 76 at an angle θ, which is preferably 120°, relative to the central axis 68 of the die 60. The second inclined surface 76 extends from the first inclined surface 74 to the central passageway 66, at an angle φ, which is preferably 103° relative to the central axis 68 of the die 60. The size of the die 60 used is dictated by the size of the punch 10a used.

The angle at which the second inclined surface 76 of the die 40 is provided and the shape of the second inclined surface 76 mirrors the angle at which the engaging surfaces 38a, 38b of the punch 10a are provided and the shape of the engaging surfaces 38a, 38b, such that the second inclined surface 76 and the engaging surfaces 38a, 38b mate when the punch 10a is fully inserted into the die 60. The piercing points P1, P2, the cutting surfaces 30b, 32b and the engaging surfaces 38a, 38b form the leading edge 29 of the working face 14 when the punch 10a is inserted into the die 40.

FIG. 11 shows the punch 10a. just before “bottoming” out on the die 60, that is, when the punch 10a is driven too far into the die 60, i.e., advancement of the punch 10a is not stopped before the leading edge 29 of the punch 10a contacts the base wall 62. of the die 60 and the punch 10a “bottoms” out on the die 60. When the punch 10a bottoms out on the die 60, the engaging surfaces 38a, 38b engage with the second inclined surface 76 of the base wall 62. As a result, the force of the impact is distributed over a large surface area of the punch 10a (the area of the engaging surfaces 38a, 38b) and damage to the piercing points P1, P2 and to the cutting surfaces 30b, 32b of the punch 10a is minimized or eliminated by reducing or eliminating the deformation of the piercing points P1, P2 and to the cutting surfaces 30b, 32b. The piercing points P1, P2 and the cutting surfaces 30b, 32b do not engage with the first inclined surface 74 as there is a gap 80 between the piercing points P1, P2/cutting surfaces 30b, 32b and the first inclined surface 74.

The die 60 of the present invention can be easily manufactured. Like the prior art die 40, the die 60 is turned on a lathe. Since the base wall 62 is not flat on its inner surface 72 like the prior art die 40, this die 60 reduces the material removed to make the die 60. There is no associated increase with the material or labor costs to manufacture the present die 60 versus the prior art die 40. The die 60 and the punch to be used therewith, for example punch 10a, can be used with all existing manual, electric, and hydraulic wrenches and actuators. The die 60 is interchangeable with the dies already in the field.

While a preferred embodiment of the present invention is shown and described, it is envisioned that those skilled in the art may devise various modifications of the present invention without departing from the spirit and scope of the appended claims.

What is claimed is:

1. A die for use with a punch capable of piercing and cutting a workpiece, said die comprising:
a base wall having a perimeter, an outer surface and an inner surface;
a depending wall extending from said perimeter;
a passageway extending through said base wall; and
a central axis extending through said passageway, said outer surface of said base wall being perpendicular to said axis, said inner surface of said base wall having a portion which is angled relative to said central axis at an angle that is different than 90 degrees and engages the punch when the punch is fully inserted into the die.

2. The die of claim 1, wherein said portion is proximate to said passageway.

3. The die of claim 1, wherein said base wall includes a first portion which is angled relative to said axis at a first predetermined angle, and a second portion which is angled relative to said axis at a second predetermined angle, said first and second angles being different.

4. The die of claim 3, wherein said first predetermined angle is greater than said second predetermined angle.

5. The die of claim 4, wherein said first angle is 120°.

6. The die of claim 5, wherein said second angle is 103°.

7. An assembly comprising:
a die comprising a base wall having a perimeter, an outer surface and an inner surface, a depending wall extending from said perimeter, a passageway extending through said base wall, and a central axis extending through said passageway, said outer surface of said base wall being perpendicular to said central axis, said inner surface of said base wall having at least one portion being angled relative to said central axis at an angle that is different than 90 degrees; and
a punch comprising a body having a bore therethrough, a leading edge on said body capable of piercing a workpiece, and cutting edges on said body for cutting a hole in the workpiece, said leading edge having piercing points and an inclined surface extending from each piercing point to said bore, said inclined surfaces engaging with said portion of said inner surface of said die and said piercing points do not engage with said inner surface of said base wall of said die when said leading edge engages with said inner surface of said base wall of said die.

8. The assembly of claim 7, wherein said base wall includes a first portion which is angled relative to said axis at a first predetermined angle, and a second portion which is angled relative to said axis at a second predetermined angle, said first and second angles being different, said inclined surfaces of said punch engaging with said second portion of said base wall.

9. The assembly of claim 8, wherein each said inclined surface of said leading edge of said punch includes a cutting surface and an engaging surface which is wider than said cutting surface, said engaging surfaces engaging with said second portion of said inner surface of said base.

10. The assembly of claim 8, wherein said first portion is angled at an angle greater than said angle of said second portion.

11. The assembly of claim 10, wherein each said inclined surface of said leading edge of said punch includes a cutting surface and an engaging surface Which is wider than said cutting surface, said engaging surfaces engaging with said second portion of said inner surface of said base.

12. The assembly of claim 7, wherein each said inclined surface of said leading edge of said punch includes a cutting surface and an engaging surface which is wider than said cutting surface, said engaging surfaces engaging with said inner surface of said base.

13. The assembly of claim 12, wherein each said engaging surface is proximate to said bore.

14. The assembly of claim 7, wherein each said engaging surface is proximate to said bore.
